(19) United States
(12) Patent Application Publication
(10) Pub. No.: US 2018/0181228 A1
(43) Pub. Date: Jun. 28, 2018

(54) FORCE TOUCH STRUCTURE

(71) Applicants: Shenzhen China Star Optoelectronics Technology Co., Ltd., Shenzhen, Guangdong (CN); WUHAN CHINA STAR OPTOELECTRONICS TECHNOLOGY CO., LTD., Wuhan, Hubei, (CN)

(72) Inventors: Man LI, Shenzhen, Guangdong (CN); Zhenzhou XING, Shenzhen, Guangdong (CN); Xingling GUO, Shenzhen, Guangdong (CN)

(73) Assignees: Shenzhen China Star Optoelectronics Technology Co., Ltd., Shenzhen, Guangdong (CN); WUHAN CHINA STAR OPTOELECTRONICS TECHNOLOGY CO., LTD, Wuhan, Hubei, (CN)

(21) Appl. No.: 15/310,434

(22) PCT Filed: Sep. 14, 2016
(86) PCT No.: PCT/CN2016/099073

§ 371 Date: Nov. 10, 2016

(30) Foreign Application Priority Data
Jul. 13, 2016 (CN) 201610548514.X

(51) Int. Cl. G06F 3/044; G02F 1/1333; G02F 1/1335

(52) U.S. Cl. CPC G06F 3/044; G02F 1/13338; G02F 1/134363; G06F 2203/04104; G06F 2203/04107; G02F 1/133512

(57) ABSTRACT

The present application discloses a force touch structure, the force touch structure including a touching layer, a display layer and a force sensing layer, the touching layer, the display layer and the force sensing layer are sequentially laminated, the force touch structure further including an independent shielding metal layer.

### FIELD OF THE INVENTION

The present application relates to a force touch structure, and more particularly to a force touch structure to shield the electric field generated along the vertical direction of the display layer during display.

### BACKGROUND OF THE INVENTION

With the development of smart phones, tablet, currently, the function of the force touch became another man-machine communication technology following the Multi-Touch, but there are still many problems to be improved, for example, the force touch structure can be easily interference by the other signals of the mobile device, thus affecting the sensing accuracy of the pressure sense signal.

### SUMMARY OF THE INVENTION

In order to overcome the insufficient of the present technology, a force touch structure is provided in the present application.

In accordance with one aspect of the present application, a force touch structure is provided, the force touch structure including a touching layer, a display layer and a force sensing layer, the touching layer, the display layer and the force sensing layer are sequentially laminated, the force touch structure further including an independent shielding metal layer.

Preferred, the force sensing layer including an insulating dielectric layer and a force sensing film.

Preferred, the insulating dielectric layer is an air gap layer.

Preferred, the display layer is a liquid crystal display panel.

Preferred, when the shielding metal layer is disposed between the backlight module of the liquid crystal display panel and the air gap layer, the shielding metal layer is an opaque conductive layer.

Preferred, the opaque conductive layer is one or more metal of molybdenum, aluminum, copper, gold and silver.

Preferred, when the shielding metal layer is disposed between the rear glass of the liquid crystal display panel and the backlight module of the liquid crystal display panel, the shielding metal layer is a transparent conductive layer.

Preferred, the transparent conductive layer is indium tin oxide film.

Preferred, the display layer is basing on the in-plane switching mode.

The present application not only can shield the electric field in the vertical direction of the display layer, but also enhance the accuracy of the display and touch of the touch device at the same time.

### BRIEF DESCRIPTION OF THE DRAWINGS

In order to more clearly illustrate the embodiments of the present application or prior art, the following figures will be described in the embodiments are briefly introduced. It is obvious that the drawings are merely some embodiments of the present application, those of ordinary skill in this field can obtain other figures according to these figures without paying the premise.

FIG. 1 illustrates a schematic view of an electric field generated by the display layer when displaying in accordance with an exemplary embodiment of the present application;

FIG. 2 illustrates a schematic view of a force touch structure in accordance with an exemplary embodiment of the present application;

FIG. 3 illustrates a schematic view of a force touch structure disposed with shielding metal layer in accordance with an exemplary embodiment of the present application; and

FIG. 4 illustrates a schematic view of another force touch structure disposed with shielding metal layer in accordance with an exemplary embodiment of the present application.

### DETAILED DESCRIPTION OF PREFERRED EMBODIMENTS

Embodiments of the present application are described in detail with the technical matters, structural features, achieved objects, and effects with reference to the accompanying drawings as follows. It is clear that the described embodiments are part of embodiments of the present application, but not all embodiments. Based on the embodiments of the present application, all other embodiments to those of ordinary skill in the premise of no creative efforts obtained should be considered within the scope of protection of the present application.

Specifically, the terminologies in the embodiments of the present application are merely for describing the purpose of the certain embodiment, but not to limit the invention. Examples and the claims be implemented in the present application requires the use of the singular form of the book “an”, “the” and “the” are intend to include most forms unless the context clearly dictates otherwise. It should also be understood that the terminology used herein that “and/or” means and includes any or all possible combinations of one or more of the associated listed items.

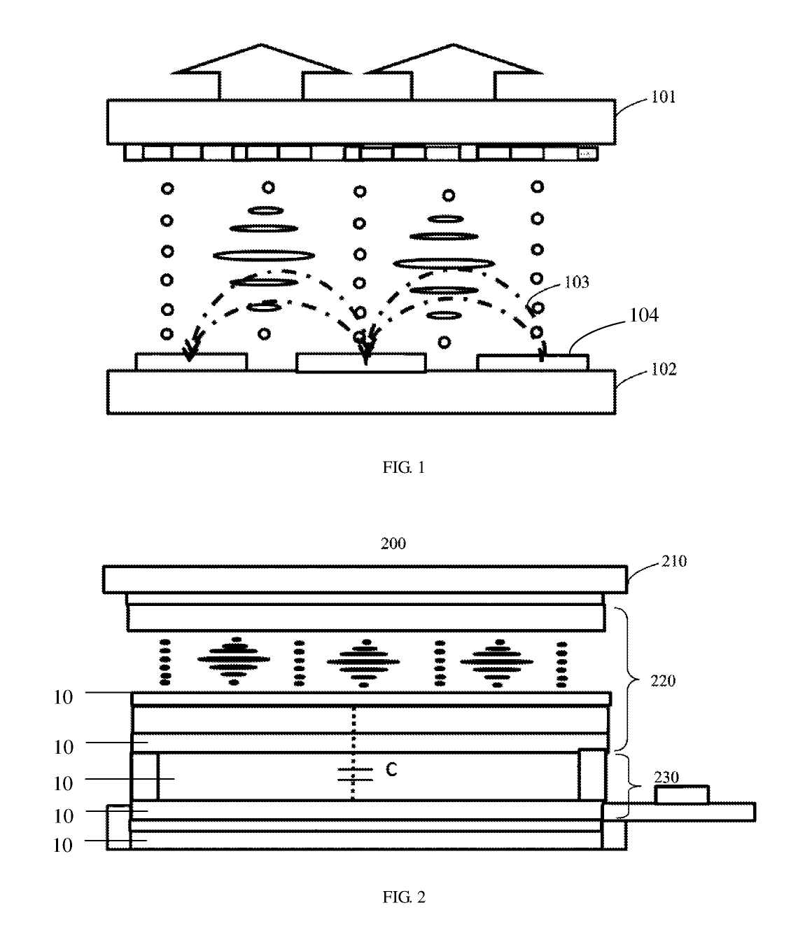

FIG. 1 illustrates a schematic view of an electric field 103 generated by the display layer when displaying in accordance with an exemplary embodiment of the present application. Referring to FIG. 1 to illustrate a liquid crystal display panel with the force touch structure, of course, it can be other display panel (e.g., OLED panel). The dotted line shown in the figure is the electric field 103 generated between a front glass (CF glass) 101 and a rear glass (TFT class) 102 of the liquid crystal display panel when displaying. For such electric field usually generates the electric field with two directions basing on the in-plane switching display technology of the liquid crystal display apparatus, i.e., one electric field perpendicular to the direction parallel to the panel, one electric field parallel to the direction of the panel, wherein the electric field perpendicular to the direction parallel to the panel will produce signal interference to the liquid crystal display apparatus with in-plane switching display mode (for example, in-plane switching, IPS mode or fringe field switching, FFS mode).

FIG. 2 illustrates a schematic view of a force touch structure 200 in accordance with an exemplary embodiment of the present application.

Referring to FIG. 2, the force touch structure 200 is provided in the exemplary embodiment of the present application, it can be seen from the figure, the force touch structure 200 is composed by laminating three parts of a touching layer 210, a display layer 220 and a force sensing layer 230 sequentially. In the present embodiment, the touching layer 210 can be formed by a touch Panel, referred to as TP). The display layer 220 can be formed by a liquid crystal display, referred to LCD, the LCD panel illustrated in FIG. besides including the front glass(CF glass), the liquid crystal layer, VCOM electrode 104 and the rear glass (TFT glass), further includes a layer of backlight module, BLM 105 in the bottom portion. The force sensing layer 230 can be formed by an insulating dielectric layer 106 and a force sensing film (force film) 107, in an alternative embodiment, the insulating dielectric layer can be an air gap layer, in addition, it can also be achieved by adopting other suitable insulating dielectric layer. In the specific embodiment, the entire touch device 200 can be adhesion to the metal frame 108 of a cell phone or other mobile devices by adaption of an optical clear adhesive, OCA, in order to achieve a force touch display.

When the touch device 200 is power on by the IC and the FPC illustrated in the FIG., a force touch capacitance C of the touch device 200 is formed between the VCOM electrode 104 and the force sensing film 107 of the display layer 220, wherein the VCOM electrode 104 of the display layer 220 is one electrode of the force touch capacitance C, the force sensing film 107 is the other electrode of the force touch capacitance C.

In the specific embodiment, when a user's finger touch the touching layer 210 of the touch device 200, since the different degrees of deformation of the force sensing film of the force sensing layer 230 causing the different gap size of the force touch capacitance C, and thus causes a change in the force capacitance, at this time, the change of the capacitance can be converted into the change of an electric signal and transmitted to the processor of the touch IC illustrated in FIG., the processor thereby positioning the position and the signal by the force touch of the user's finger, eventually issued a specific instructions to ask cell phones and other mobile touch device to perform specific actions.

However, the electric field 103 shown in FIG. 1 is perpendicular to the direction parallel to the panel and generates interference to the force sensing signal sensed by the force touch device 200 of the present embodiment, and have an adverse effect to the accuracy of the display and touch of the touch device 200.

In order to avoid the influence of the electric field 103 shown in FIG. 1 that is perpendicular to the direction parallel to the panel, it can be considered to shield off the electric field perpendicular to the direction parallel to the panel. In an alternative embodiment, a shielding metal layer can be disposed between the display layer 220 and the force sensing layer 230, when the touch device 200 is power on by the IC and the FPC illustrated in the FIG., the force capacitance formed between the shielding metal layer and the force sensing film of the force sensing layer 230 can sense the force variation of the finger on the touching layer, while the shielding metal layer can shield the signal interference to the force sensing layer 230 by the electric field generated along the vertical direction of the display layer 220 during display.

The following further detail describes the embodiment of disposing the shielding metal layer in the force touch structure.

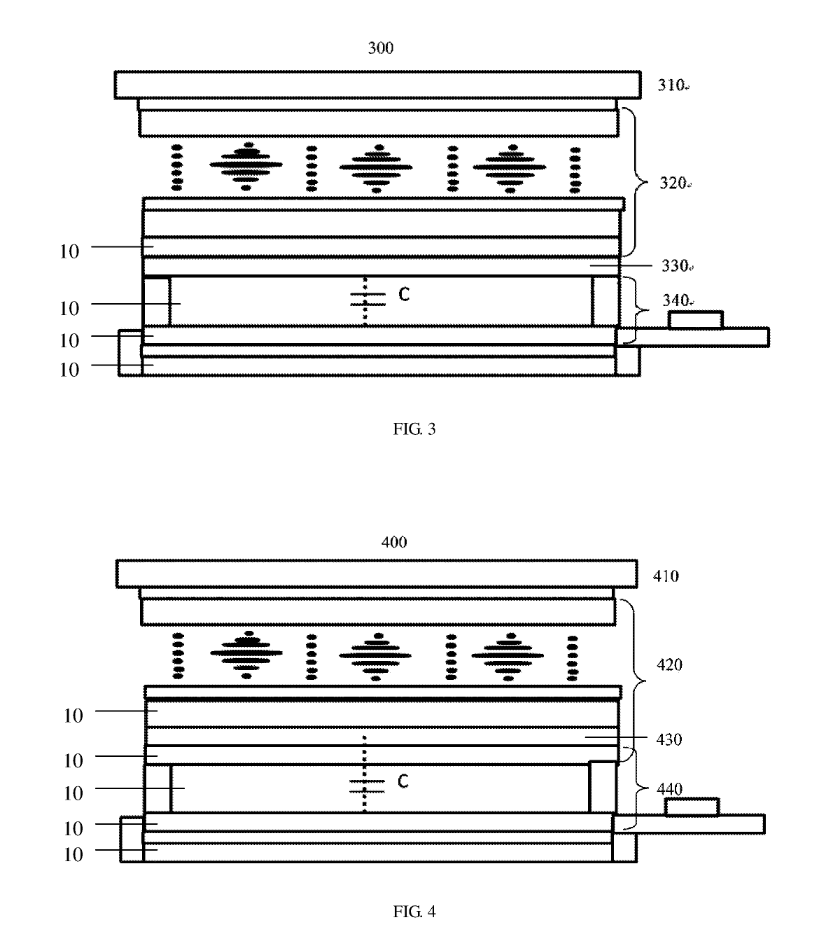

FIG. 3 illustrates a schematic view of a force touch structure disposed with shielding metal layer in accordance with an exemplary embodiment of the present application.

Referring to FIG. 3, the force touch structure 300 disposed with the shielding metal layer is provided in the exemplary embodiment of the present application, it can be seen from the FIG., the force touch structure 300 is composed by laminating four parts of a touching layer 310, a display layer 320, a shielding metal layer (shielding ITO) 330 and a force sensing layer 340 sequentially. Wherein the shielding metal layer 330 is disposed between the air gap layer 106 of the backlight module 105 of the display layer 320 and the force sensing layer 340.

When the touch device 300 is power on by the IC and the FPC illustrated in the FIG., a force touch capacitance C is formed between the shielding metal layer 330 and the force sensing film 107 in the touch device 300, wherein the shielding metal layer 330 is one electrode of the force touch capacitance C, the force sensing film 107 is the other electrode of the force touch capacitance C. By adapting this embodiment, not only can shield the electric field in the vertical direction of the display layer 320, but also enhance the accuracy of the display and touch of the touch device 300 at the same time.

Furthermore, in order to obtain better display and force touch effects, in the present embodiment, the shielding metal layer 430 can be adapted as an opaque conductive layer, the opaque conductive layer can be one or a combination of molybdenum, aluminum, copper, gold and silver and other conductive metal.

FIG. 4 illustrates a schematic view of a force touch structure disposed with shielding metal layer in accordance with another exemplary embodiment of the present application.

Referring to FIG. 4, the force touch structure 400 disposed with the shielding metal layer is provided in the exemplary embodiment of the present application, it can be seen from the FIG., the force touch structure 400 is composed by laminating four parts of a touching layer 410, a display layer 420, a shielding metal layer 430 and a force sensing layer 440 sequentially. Wherein the shielding metal layer 430 is disposed between the rear glass 102 of the display layer 420 and the backlight module 105 of the display layer 420.

Similarly, when the touch device 400 is power on by the IC and the FPC illustrated in the FIG., a force touch capacitance C is formed between the shielding metal layer 430 and the force sensing film 107 in the touch device 400, wherein the shielding metal layer 430 is one electrode of the force touch capacitance C, the force sensing film 107 is the other electrode of the force touch capacitance C. By adapting this embodiment, it can also shield the electric field in the vertical direction of the display layer 320, and enhance the accuracy of the display and touch of the touch device.

Similarly, in order to obtain better display and force touch effects, in the present embodiment, the shielding metal layer 430 can be adapted as a transparent conductive layer, such as, indium tin oxide (ITO) film.

It can be seen from the respective embodiments described above, comparing to the conventional force touch structure, the improved entire force touch structure further includes a shielding metal layer disposed between the display layer and the force sensing layer, so that when the power is applied, a force capacitance is formed between the shielding metal layer and the force sensing film of the force sensing layer, to sense the force variation of the finger on the touching layer, and shield the electric field generated along the vertical direction of the display layer during display.

Above are embodiments of the present application, which does not limit the scope of the present application. Any modifications, equivalent replacements or improvements within the spirit and principles of the embodiment described above should be covered by the protected scope of the invention.

What is claimed is:

1. A force touch structure, comprising:
a touching layer;
a display layer; and
a force sensing layer, wherein the touching layer , the display layer and the force sensing layer are sequentially laminated;
wherein the force touch structure further comprising an independent shielding metal layer.

2. The force touch structure according to claim 1, wherein the force sensing layer comprising an insulating dielectric layer and a force sensing film.

3. The force touch structure according to claim 2, wherein the insulating dielectric layer is an air gap layer.

4. The force touch structure according to claim 3, wherein the display layer is a liquid crystal display panel.

5. The force touch structure according to claim 4, wherein when the shielding metal layer is disposed between the backlight module of the liquid crystal display panel and the air gap layer, the shielding metal layer is an opaque conductive layer.

6. The force touch structure according to claim 5, wherein the opaque conductive layer is one or more metal of molybdenum, aluminum, copper, gold and silver.

7. The force touch structure according to claim 4, wherein when the shielding metal layer is disposed between the rear glass of the liquid crystal display panel and the backlight module of the liquid crystal display panel, the shielding metal layer is a transparent conductive layer.

8. The force touch structure according to claim 7, wherein the transparent conductive layer is indium tin oxide film.

9. The force touch structure according to claim 1, wherein the display layer is basing on the in-plane switching mode.

10. The force touch structure according to claim 4, wherein the display layer is basing on the in-plane switching mode.
